(19) United States
(12) Patent Application Publication
(10) Pub. No.: US 2010/0072238 A1
(43) Pub. Date: Mar. 25, 2010

(54) BICYCLE STORAGE APPARATUS

(75) Inventors: Pierce J. Pape, Atlanta, GA (US); Dean Theodore, Calabasas, CA (US)

Correspondence Address: Nelson Mullins Riley & Scarborough LLP;IP Department, 100 North Tryon Street, 42nd Floor, Charlotte, NC, 28202-4000, US

(73) Assignee: SPORTING INNOVATIONS GROUP, LLC, Atlanta, GA (US)

(21) Appl. No.: 12/561,611

(22) Filed: Sep. 17, 2009

Related U.S. Application Data
(60) Provisional application No. 61/098,313, filed on Sep. 19, 2008.

(51) Int. Cl. B62J 9/00

(52) U.S. Cl. 224/425; 224/431; 224/439

(57) ABSTRACT

A bicycle storage system has an elongated base having a first end, a second end, a plurality of straps for releasably securing the elongated base to a bicycle frame, and a top surface. A storage compartment has a bottom surface configured to be releasably attached to the elongated base top surface. The storage compartment may be releasably secured to the elongate base by hook and loop material. The storage compartment may be insulated and may contain antimicrobial material.

### CLAIM OF PRIORITY

The present application claims priority to U.S. Provisional Patent Application Ser. No. 61/098,313, filed Sep. 19, 2008, entitled Bicycle Storage Apparatus, the entire disclosure of which is incorporated by reference herein.

### FIELD OF THE INVENTION

The present invention relates generally to a storage apparatus for use on a bicycle. More particularly, this invention pertains to a system for interchangeably mounting a variety of storage compartments, either alone or in simultaneous combination, to a bicycle frame.

### BACKGROUND OF THE INVENTION

Many accessories are currently useful to bicyclists. These include removable fenders over the front and/or rear wheels, bicycle cargo carrying racks that may be positioned over either wheel, cargo-carrying racks with integral baskets, saddlebags or panniers-that are generally mounted on a cargo-carrying rack and even small trailers for carrying children or other cargo.

One area of great need for storage accessories is for cycling athletes. In cycling, often participants ride great distances, which deplete their hydration and electrolytes. Thus, cyclists carry large quantities of nutritional supplements and energy products, such as salt tablets, energy bars, energy gels, etc. In some cases, cyclists tape packages of these products to the handlebars, place the items in a fanny pack or other tote or store the items in an open container secured to the bike frame. In prior art systems, an open container is secured to the bicycle frame and consists of a fixed open-ended container. In other prior art systems, various bicycle seat packs have been proposed for use in carrying such items such as an inner tube, tire pressure gauge, etc. These packs are soft-sided and include a stiffener that gives form and substance to and reinforces upper and lower surfaces of the pack. A zipper extends a little over halfway around a rearwardly facing end of the pack. On disadvantage of seat type storage devices is that they are difficult to reach when actively riding due to less than optimal zipper length and placement.

Bicycle accessories of the type described above are typically secured to the frame of a bicycle using threaded fasteners driven into a braze-on, metal straps that are passed around the frame, pipe clamps, U-bolts, duct tape and the like. Where a member of a bicycle frame is not in a predetermined orientation or where the frame member is of a different size or shape, prior art accessory attachments are not easily modified to accommodate common variations in bicycle frame size and shape.

The present invention recognizes and addresses the foregoing disadvantages, and others, of prior art constructions and methods. Various combinations and sub-combinations of the disclosed elements, as well as methods of utilizing same, which are discussed in detail below, provide other objects, features and aspects of the present invention.

### SUMMARY OF THE INVENTION

The present invention recognizes and addresses disadvantages of prior art constructions and methods, and it is an object of the present invention to provide a bicycle storage apparatus comprises a base having a first end, a second end, a first portion extending from the first end, a second portion extending between the first portion and the second end, and a top surface. At least one storage compartment having a bottom surface is configured to be releasably attached to the elongated base top surface by a connector. The first portion, when mounted on a bicycle frame, is disposed at angle with respect to the second portion, when the second portion is mounted on the bicycle frame.

In some embodiments, the connector is formed from a hook and loop material. In yet other embodiments, the elongated base further comprises a bottom surface formed from a non-slip material. In some of these embodiments, the non-slip material is rubber.

In still other embodiments, the at least one storage compartment further comprises a plurality of sidewalls coupled to the at least one compartment bottom surface to define a storage area. In some of these embodiments, the at least one compartment base and the sidewalls are insulated. In other of these embodiments, the at least one compartment further comprises a top coupled to one of the sidewalls.

In yet other embodiments, the bicycle storage system further comprises a plurality of storage compartments configured to be releasably secured to the elongated base top surface by a respective connector.

In another preferred embodiment, a bicycle storage system comprises an elongated base having a first end, a second end, a plurality of releasable connectors coupled to the elongated base and configured to releasably secure the elongated base to a bicycle frame, a top surface, and a bottom surface containing a non-slip surface. A plurality of storage compartments is configured to be releasably secured to the elongated base top surface by a respective connector.

In some embodiments, at least one of the plurality of storage compartments has a cover that is pivotally connected to a sidewall of the at least one of the plurality of storage compartments. In other embodiments, at least one of the plurality of storage compartments is insulated. In yet other embodiments, at least one of the plurality of storage compartments has an inner wall surface containing an anti-bacterial material. In still other embodiments, at least one of the plurality of storage compartments is formed from a ballistic nylon material. In some embodiments, each of the elongated base plurality of connectors is formed from a strap that releasably secures the elongated base to the bicycle frame.

In yet another preferred embodiment, a bicycle storage system comprises an elongated base having a first end, a second end, a plurality of straps for releasably securing the elongated base to a bicycle frame, and a top surface. At least one storage compartment has a bottom surface configured to be releasably attached to the elongated base top surface.

In some embodiments, a connector releasably couples the at least one storage compartment bottom surface to the elongated base top surface. In yet other embodiments, the connector is formed from hook and loop material.

In still other embodiments, each of the plurality of elongated base straps is formed from a first strap and a second strap, where one of the first strap and the second strap contains hooks and another of the first strap and the second strap contains loops for releasably securing the elongated base to the bicycle frame.

In other embodiments, the elongated base first portion is disposed at an angle with respect to the elongated base second portion. In yet other embodiments, the at least one compartment is insulated.

Various combinations and sub-combinations of the disclosed elements, as well as methods of utilizing same, which are discussed in detail below, provide other objects, features and aspects of the present invention.

The accompanying drawings, which are incorporated in and constitute a part of this specification, illustrate one or more embodiments of stacked displays of the present invention.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is an exploded perspective view of a bicycle storage system in accordance with an embodiment of the present invention;

FIG. 2 is a perspective view of a mounting strip for use with the bicycle storage system of FIG. 1;

FIG. 3 is a perspective view of the bicycle storage device of FIG. 1, shown being configured by the user;

FIG. 4 is a perspective view of bicycle storage device of FIG. 1, shown with one storage pouch removed;

FIG. 5 is a perspective view of the bicycle storage device of FIG. 1;

FIG. 6 is a side perspective view of the bicycle storage device of FIG. 1;

FIG. 7 is a side perspective view of the bicycle storage device of FIG. 1, shown with nutritional products in the storage compartments;

FIG. 8 is a side perspective view of the bicycle storage device of FIG. 1, shown in one configuration;

FIG. 9 is a perspective view of the bicycle storage device of FIG. 8, shown with the rear storage pouch open;

FIG. 10 is a perspective view of the bicycle storage device of FIG. 8, showing the inside walls of the rear storage pouch;

FIG. 11 is a partial perspective view of the bicycle storage device of FIG. 1, showing a close-up view of the front storage compartment;

FIG. 12 is a close-up perspective view of the bicycle storage device of FIG. 1;

FIG. 13 is a side perspective view of the bicycle storage device of FIG. 1, shown in another configuration having only two storage pouches;

FIG. 14 is a side perspective view of the bicycle storage device of FIG. 1, shown in another configuration having only one storage pouch; and

FIG. 15 is a side perspective view of the bicycle storage device of FIG. 1, shown in another configuration having only one storage pouch.

Repeat use of reference characters in the present specification and drawings is intended to represent same or analogous features or elements of the invention.

### DETAILED DESCRIPTION

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention cover such modifications and variations. Additional aspects and advantages of the invention will be set forth in part in the description that follows and, in part, will be obvious from the description, or may be learned by practice of the invention.

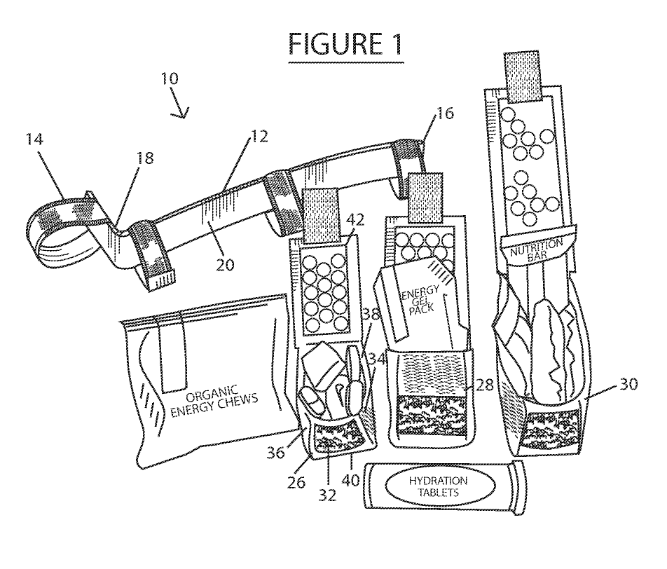

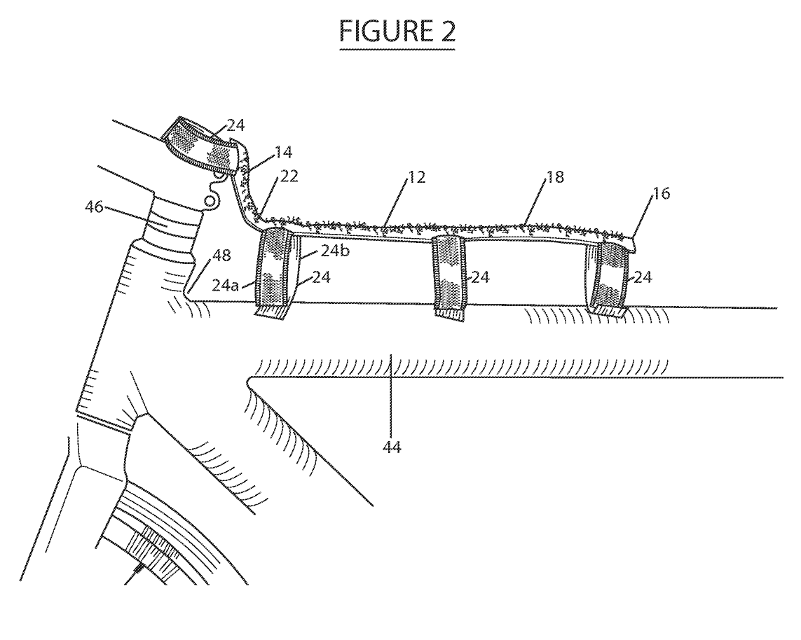

Referring to FIGS. 1 and 2, a bicycle storage device 10 has a base 12 having a first end 14 and a second end 16. Base 12 has a top surface 18 and a bottom surface 20. Bottom surface 20 may be formed from any suitable polymer or elastomers so that it provides a non slip surface. In one embodiment, top surface 18 is formed from a loop or hook material. A bend portion 22 is formed intermediate a central portion of the base and base first end 14. Base 12 also contains a plurality of connector straps 24 formed from a first strap 24a and a second strap 24b (FIG. 2). One of straps 24a and 24b contains a hook material and the other contains a loop material. The hook and loop material allows the two halves of the strap to wrap around a frame member and to releasably connect to one another. It should be understood that other suitable connecting means may be contained on straps 24a and 24b, for example snaps, buckles, etc.

Bicycle storage device 10 also contains a plurality of storage compartments 26, 28 and 30. Each of these compartments has four sidewalls 32, 34, 36, and 38 and a bottom 40 to form a polygonal storage compartment. For purposes of ease and clarity, only one of storage compartments 26, 28 and 30 are numbered. However, each of the compartments contains similar structures. In alternate embodiments, each of the compartments may take on various forms for example square, rectangular, round, oval, etc. Moreover, the width of each storage compartment may vary. In one embodiment, the width of compartments 26, 28 and 30 are no wider then frame member 44 to ensure that the compartments do not interfere with the cyclist's knees.

A top 42 couples to at least one of the compartment sidewalls and is releasably secured to another of the sidewalls. Any suitable locking mechanisms may be used to releasably secure the top to the sidewall, for example, snaps, hook and loop materials, etc. The top, sidewalls and base may be insulated to help preserve the freshness of products that are stored within the compartments. Suitable insulated designs include a layered system, for example a three layered design including a EPE film, which is an expanded polyethylene, a high-density polyethylene middle layer and a laminated outer foil layer that is ROHS certified. It should be understood that other suitable insulation designs may be used.

Referring to FIG. 2, base 12 is installed on a bicycle frame member (top tube) 44 by wrapping straps 24a and 24b around frame member 44 and connecting the ends. Base end 14 is placed adjacent to a handlebar head tube (the portion of the frame that receives the handle bar stem) 46 and another one of the plurality of straps 24a and 24b are secured around the handlebar head tube or handle bar stem so that base bend 22 is positioned adjacent to a connection 48 between frame member 44 and handlebar head tube 46. In this position, base bottom surface 20 is adjacent frame member 44 and base top surface 18 is facing upward so that one or more compartments may be releasably secured to the base top surface.

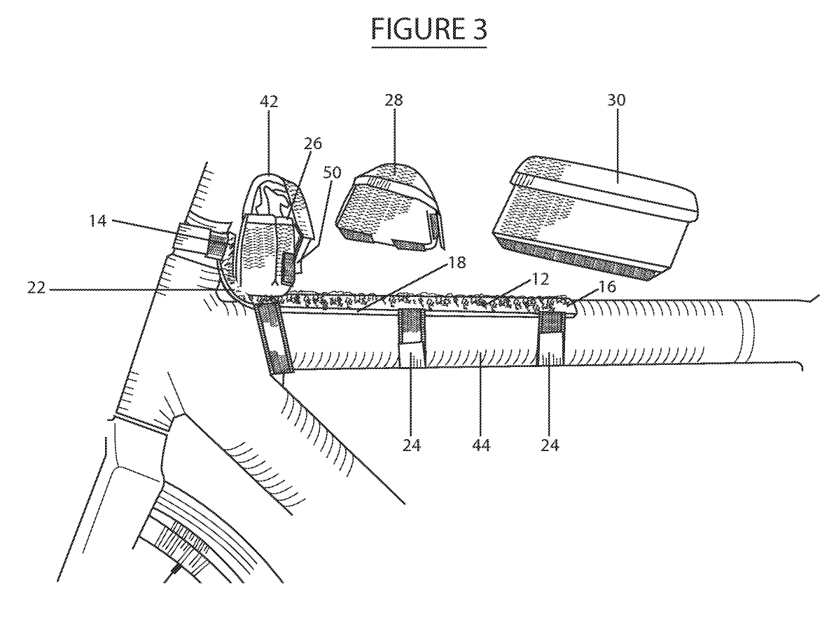

Referring to FIGS. 3-6, storage compartments 26, 28 and 30 are shown being releasably secured to base 12. In one embodiment, base top surface 18 is formed from one of hook and loop material and the other of the hook and loop material is coupled to bottom surface 40 (FIG. 1) of each of the compartments. In this configuration, each compartment can be easily attached to the base by placing the compartment adjacent to base 12 and pressing it firmly against the base.

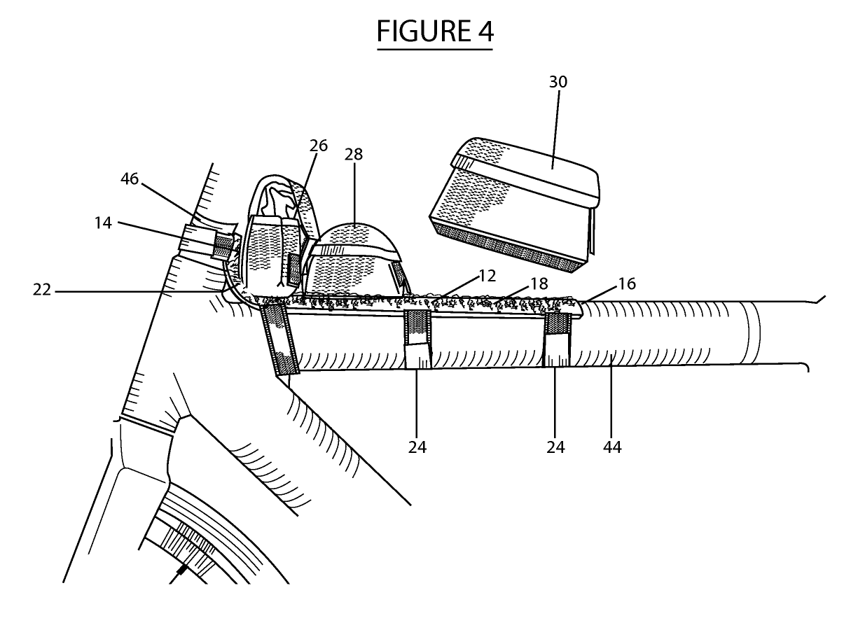

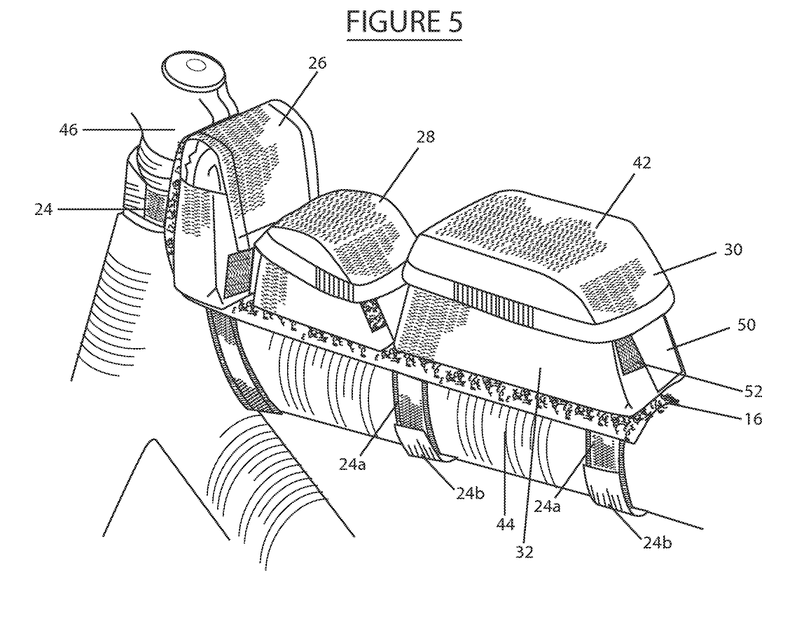

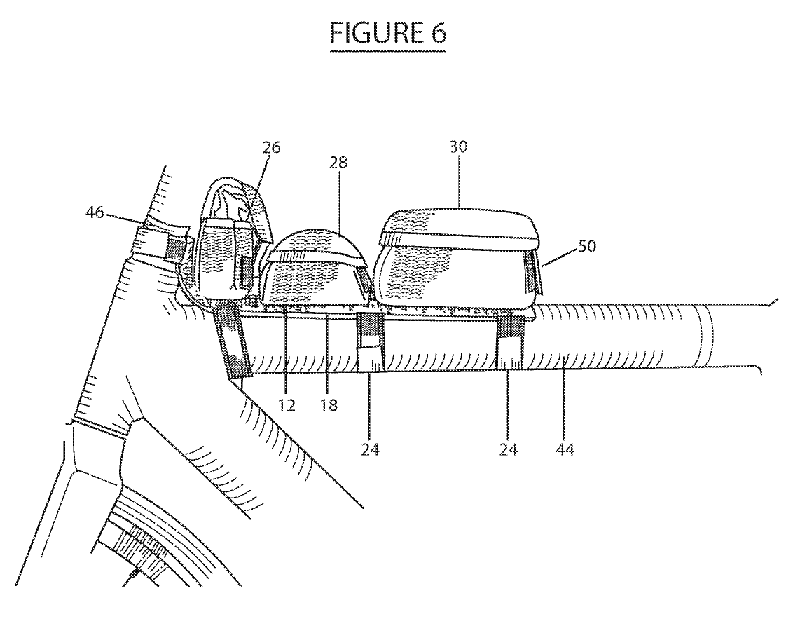

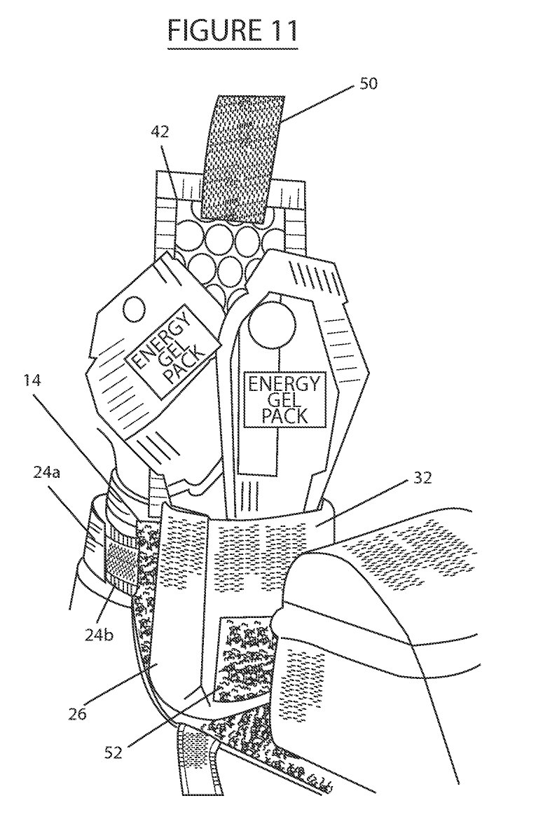

Referring to FIG. 3, storage compartment 26 is releasably attached to base 12. Referring to FIG. 4, storage compartment 28 is next placed adjacent to base 12 and pressed firmly in place so that the loop and hook material releasably secure the storage compartment to the base. Referring to FIG. 5, all three storage compartments are shown releasably attached to base 12. In this embodiment, storage compartment top 42 is shown releasably secured to compartment sidewall 32 by a latch having a first part 50 attached to top 42 and a second part 52 attached to sidewall 32. In one embodiment, first part 50 has one of a hook and a loop material and second part 52 has the other of the hook and loop material. In other embodiments, other suitable latch mechanisms may be used such as snaps, buttons, etc. FIG. 6 illustrates compartment 26 filled with nutritional supplements for use by the cyclist. FIG. 11 illustrates a partial perspective view of storage compartment 26 where a looped material 40 is attached to compartment top 42 and a hook material 52 is attached to a compartment sidewall 32. In this Figure, storage compartment 26 is shown with nutritional supplements in the compartment.

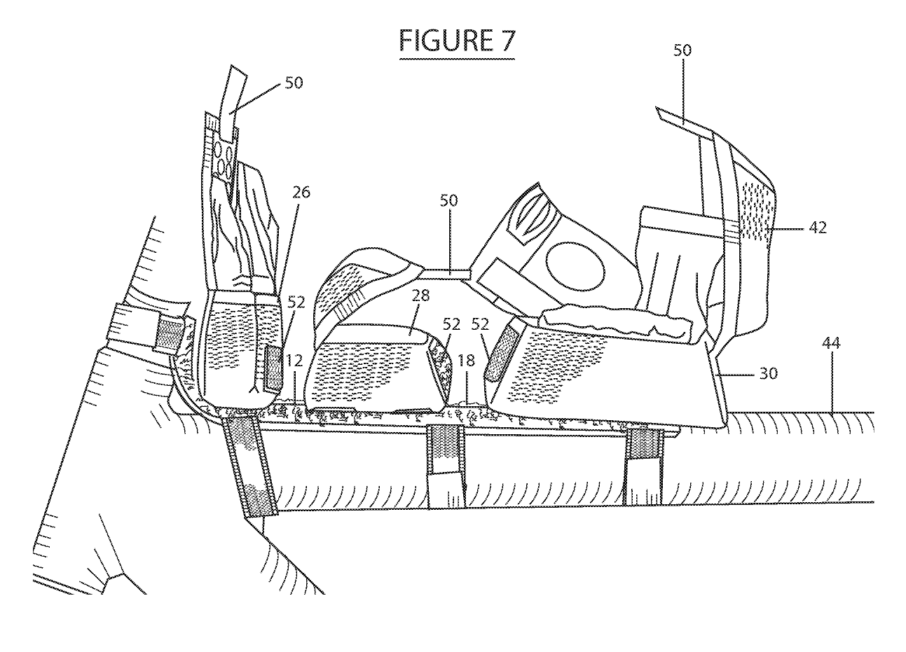

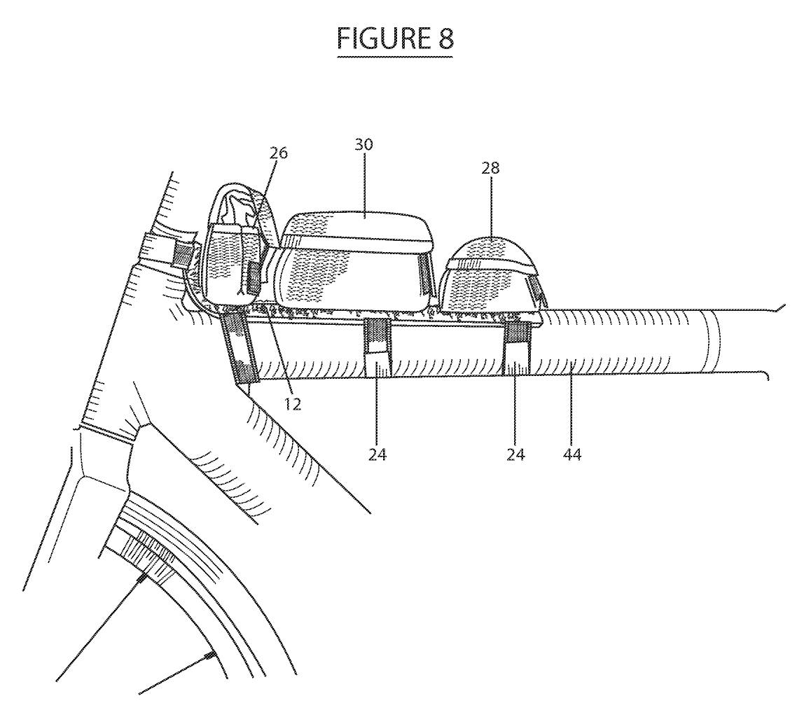

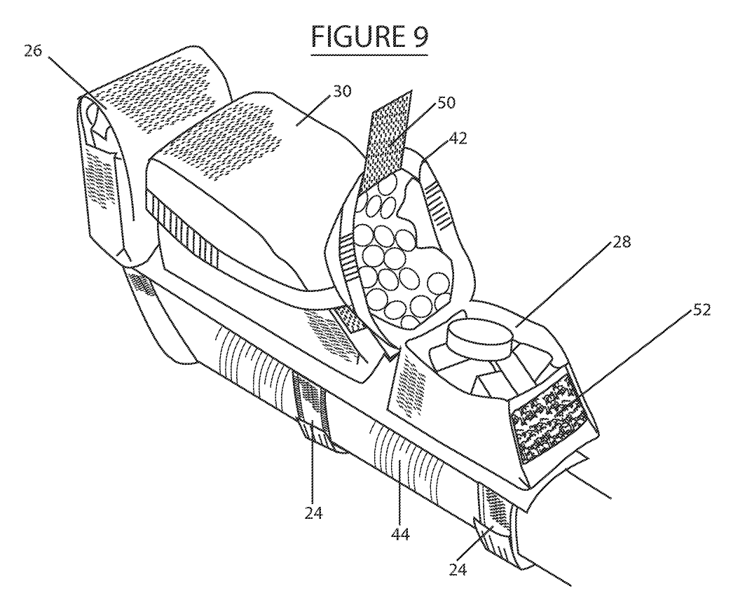

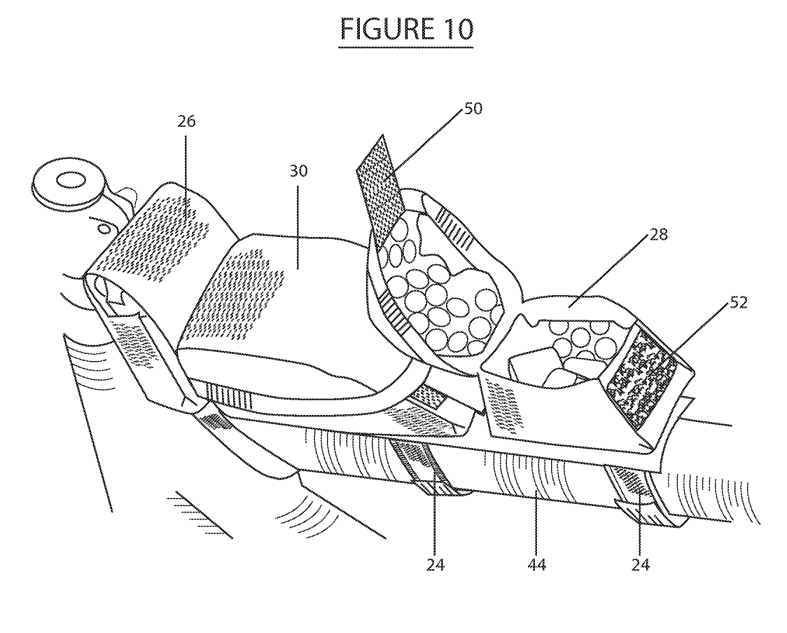

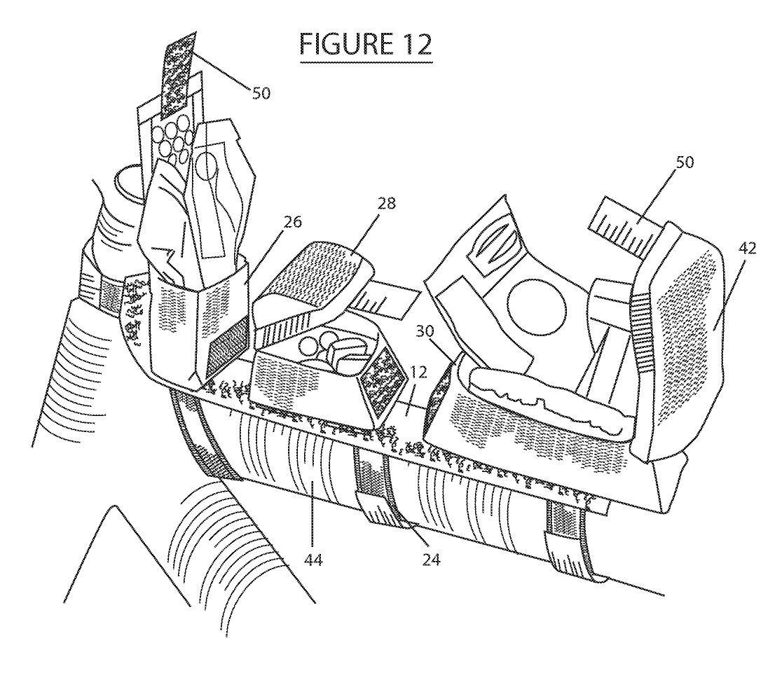

Referring to FIGS. 7 and 12, because storage compartments 26, 28 and 30 are releasably attached to base 12, the compartments can be easily configured to meet the needs of the user. For example, in this embodiment, storage compartment 30 has been turned around one-hundred and eighty degrees so that top 42 opens toward the cyclist. Referring to FIGS. 8-10, the bicycle storage device is shown in yet another configuration where storage compartment 30 is placed on base 12 intermediate storage compartments 26 and 28.

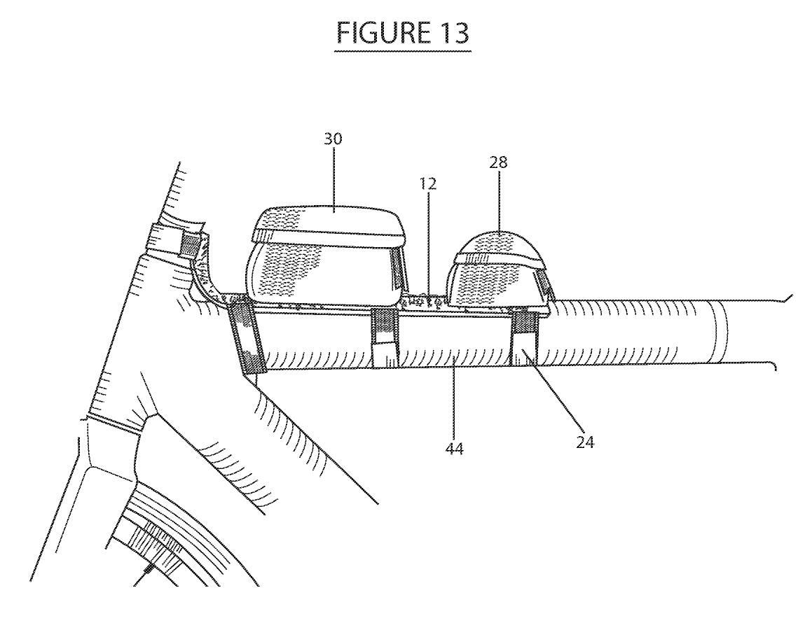

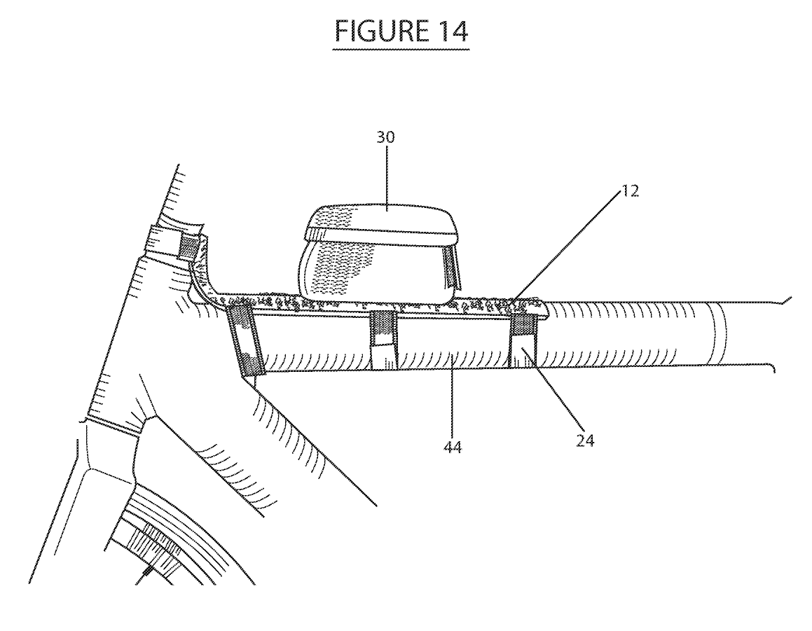

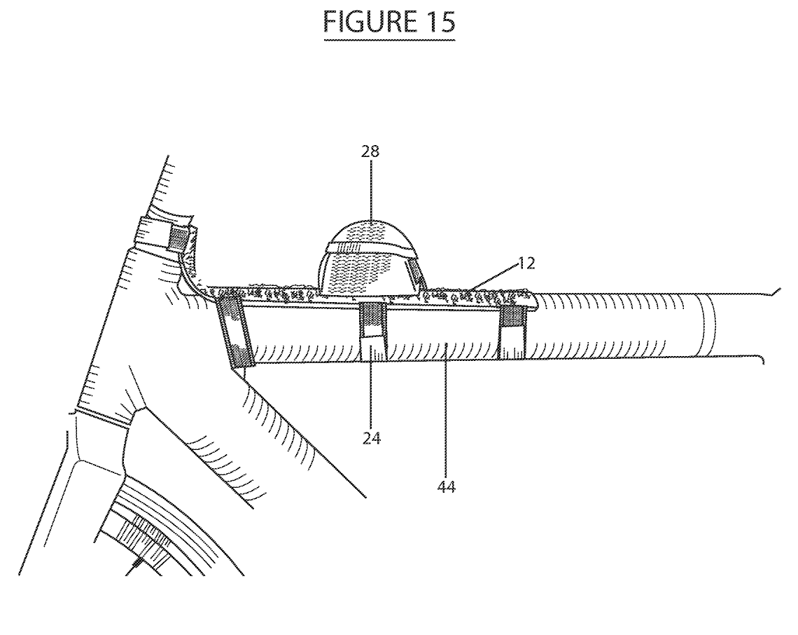

Referring to FIGS. 13-15, other configurations of bicycle storage device 10 are shown where two storage compartments 26 and 30 (FIG. 13) and one storage compartment 30 (FIG. 14) or 26 (FIG. 15) is used. Based on the various embodiments and configurations illustrated in the figures, one of skill in the art should understand that the bicycle storage device of the present invention is flexible and is easily configurable. In addition, storage compartments 26, 28 and 30 can be removed from base 12 so that they can be filled and stored in a refrigerator until the cyclist goes for a ride. This allows the contents to be cooled to maintain freshness and provide a refreshing product since the compartments are insulated.

It should also be understood that a second base (not shown in the figures) can be installed on frame member 44 opposite base portion 12. In this configuration, additional compartments can be attached to the second base, or other accessories can be releasably attached such as a cell phone holder, a pump, etc. In other embodiments, two base portions may be attached to one another at one side edge by one or more straps so that each base can be placed adjacent to frame member 42. Releasable straps can be used to releasably secure the opposite side of each base to secure the bases to the frame member. In this way, additional storage compartments can be carried on the bicycle.

While one or more preferred embodiments of the invention have been described above, it should be understood that any and all equivalent realizations of the present invention are included within the scope and spirit thereof. The embodiments depicted are presented by way of example and are not intended as limitations upon the present invention. Thus, those of ordinary skill in this art should understand that the present invention is not limited to these embodiments since modifications can be made. Therefore, it is contemplated that any and all such embodiments are included in the present invention as may fall within the scope and spirit of the invention.

What is claimed:

1. A bicycle storage apparatus comprising:
a. an base having
i. a first end,
ii. a second end,
iii. a first portion extending from said first end,
iv. a second portion extending between said first portion and said second end, and
v. a top surface,
b. at least one storage compartment having a bottom surface configured to releasably attach to said elongated base top surface by a connector,
wherein said first portion when mounted on a bicycle frame is disposed at angle with respect to said second portion when said second portion is mounted on the bicycle frame.

2. The bicycle storage apparatus of claim 1, wherein said connector is formed from a hook and loop material.

3. The bicycle storage apparatus of claim 1, said elongated base further comprising a bottom surface formed from a non-slip material.

4. The bicycle storage apparatus of claim 3, wherein said non-slip material is rubber.

5. The bicycle storage apparatus of claim 1, said at least one storage compartment further comprising a plurality of sidewalls coupled to said at least one compartment bottom surface to define a storage area.

6. The bicycle storage apparatus of claim 5, wherein said at least one compartment base and said sidewalls are insulated.

7. The bicycle storage apparatus of claim 6, wherein said at least one compartment further comprises a top coupled to one of said sidewalls.

8. The bicycle storage apparatus of claim 1, further comprising a plurality of storage compartment configured to be releasably secured to said elongated base top surface by a respective connector.

9. A bicycle storage apparatus comprising:
a. an elongated base having
i. a first end,
ii. a second end,
iii. a plurality of releasable connectors coupled to said elongated base and configured to releasably secure said elongated base to a bicycle frame,
iv. a top surface, and
v. a bottom surface containing a non-slip surface; and
b. a plurality of storage compartments configured to be releasably secured to said elongated base top surface by a respective connector.

10. The bicycle storage apparatus of claim 9, wherein at least one of said plurality of storage compartments has a cover that is pivotally connected to a sidewall of said at least one of said plurality of storage compartments.

11. The bicycle storage apparatus of claim 9, wherein at least one of said plurality of storage compartments is insulated.

12. The bicycle storage apparatus of claim 9, wherein at least one of said plurality of storage compartments has an inner wall surface containing an antimicrobial material.

13. The bicycle storage apparatus of claim 9, wherein at least one of said plurality of storage compartments is formed from a ballistic nylon material.

14. The bicycle storage apparatus of claim 9, wherein each of said elongated base plurality of connectors is formed from a strap that releasably secures said elongated base to the bicycle frame.

15. A bicycle storage apparatus comprising:
a. an elongated base having
i. a first end,
ii. a second end,
iii. a plurality of straps for releasably securing said elongated base to a bicycle frame, and
iv. a top surface,
b. at least one storage compartment having a bottom surface configured to releasably attach to said elongated base top surface.

16. The bicycle storage apparatus of claim 15, further comprising a connector for connecting said at least one storage compartment bottom surface to said elongated base top surface.

17. The bicycle storage apparatus of claim 16, wherein said connector is formed from hook and loop material.

18. The bicycle storage apparatus of claim 15, wherein each of said plurality of elongated base straps is formed from a first strap and a second strap, where one of said first strap and said second strap contains hooks and another of said first strap and said second strap contains loops for releasably securing said elongated base to the bicycle frame.

19. The bicycle storage apparatus of claim 15, wherein said elongated base first portion is disposed at an angle with respect to said elongated base second portion.

20. The bicycle storage apparatus of claim 15, wherein said at least one compartment is insulated.
